(19) United States
(12) Patent Application Publication
(10) Pub. No.: US 2025/0382089 A1
(43) Pub. Date: Dec. 18, 2025

(54) DECORATING MACHINE WITH A MONITORING UNIT

(71) Applicant: SIDEL PARTICIPATIONS, OCTEVILLE-SUR-MER (FR)

(72) Inventors: Anne-Philippe LAFON, Mantova (IT); Lorenzo GUMIRATO, Mantova (IT); Marco FERRI, Mantova (IT)

(21) Appl. No.: 18/875,586

(22) PCT Filed: May 9, 2023
(86) PCT No.: PCT/EP2023/062176

§ 371 Date: Dec. 16, 2024

(51) Int. Cl. B65C 3/26; B65C 9/40

(52) U.S. Cl. CPC B65C 3/26; B65C 9/40

(57) ABSTRACT

Described is a decorating machine for decorating containers that includes a monitoring unit that automatically and visually monitors the deformation of the containers being conveyed to automatically detect, based on the monitored deformation, the operative condition of at least one device of the transporting units of the machine and the level of defectiveness of the containers.

### TECHNICAL FIELD

The present invention relates to a decorating machine for decorating containers, provided with a monitoring unit configured for detecting different kinds of problems affecting different components of the machine.

### BACKGROUND ART

A known type of decorating machine for decorating containers comprises a plurality of transporting units for transporting respective containers, and a carousel configured for rotating on itself to convey the units, so that the transporting units transport respective containers.

The decorating machine comprises a decorating module positioned on the radial periphery of the carousel. The machine is configured so that the transported containers are sequentially labelled while the transporting unit are being conveyed by the carousel. Each transporting unit comprises a respective lower support for supporting the bottom of the container. Each transporting unit comprises also a respective upper support for pressing the container against the lower support by acting on the top of the container. The upper support is also configured for pressurizing the inner volume of the container. The upper support comprises a pressurization device for pressurizing the inner volume of the container, by generating a fluid pressurization in the inner volume of the container. The upper support comprises a head for holding the top of the container.

Currently there is no system for efficiently monitoring possible problems affecting the pressurization device or the actuation device. In particular, it is difficult to distinguish between a problem affecting a container and a problem affecting at least one of said devices.

### DISCLOSURE OF INVENTION

A monitoring unit according to any of the unit claims or according to present description is configured for automatically identifying possible problems affecting one or more devices of the transporting unit of a decorating machine, to allow a better control on the operative condition of the machine by an operator.

A decorating machine according to any of the machine claims or according to present description comprises a monitoring unit according to any of the unit claims or a monitoring unit according to present description.

The following brief description of the drawings and detailed description of the invention will be referred to a possible example embodiment of a monitoring unit according to present description and a possible example embodiment of a decorating machine according to present description. The decorating machine, in the possible example embodiment, corresponds to a labelling machine.

In the following brief description of the drawings and detailed description of the invention, the example embodiment of the monitoring unit will be defined for the sake of convenience as “monitoring unit”. In the following brief description of the drawings and detailed description of the invention, the example embodiment of the decorating machine will be defined for the sake of convenience as “machine”.

### BRIEF DESCRIPTION OF THE DRAWINGS

The following detailed description will be referred to the accompanying drawings, in which:

FIG. 1 is a schematic layout of the machine;

FIG. 2 is a detail of FIG. 1, to show more in detail the components of the transporting units which are part of the machine;

FIG. 3 shows a first instant during operation of the monitoring unit which is part of the machine;

FIG. 4 shows a second instant during operation of the monitoring unit which is part of the machine;

FIG. 5 shows a transporting unit in a first configuration;

FIG. 6 shows the transporting unit in a second configuration;

FIG. 7 shows a first type of deformation of a transported container which is monitored by the monitoring unit;

FIG. 8 shows a second type of deformation of a transported container which is monitored by the monitoring unit;

FIG. 9 shows a third type of deformation of a transported container which is monitored by the monitoring unit;

FIG. 10 shows a container which is transported by a transporting unit and a lower support which is part of the transporting unit, in a first angular position of the lower support;

FIG. 11 shows a container which is transported by a transporting unit and a lower support which is part of the transporting unit, in a second angular position of the lower support.

### DETAILED DESCRIPTION OF THE INVENTION

The machine 1 is for labelling containers B. The containers B are configured for the packaging of pourable products, and therefore are configured to contain a pourable product.

The containers may be for example bottles. The containers may be plastic bottles.

The pourable product may be a pourable food product. The product may be sparkling water, a soft drink, beer, natural water, fruit juice, wine, tea, milk, flavored water, an emulsion, a suspension, a high viscosity liquid, or a drink containing pulp and/or solid pieces. The product may alternatively be a product for home and personal care.

The machine 1 comprises a plurality of transporting units 2 for transporting respective containers B. Operatively, each transporting unit 2 transports at least one respective container B.

The machine comprises a conveyor 3. The conveyor 3 is configured for conveying the units 2, so that the containers B are transported by means of the units 2 being conveyed.

The machine 1 comprises a labelling module 4 positioned on the periphery of the conveyor 3. The machine 1 is configured so that the transported containers B are sequentially labelled while being transported.

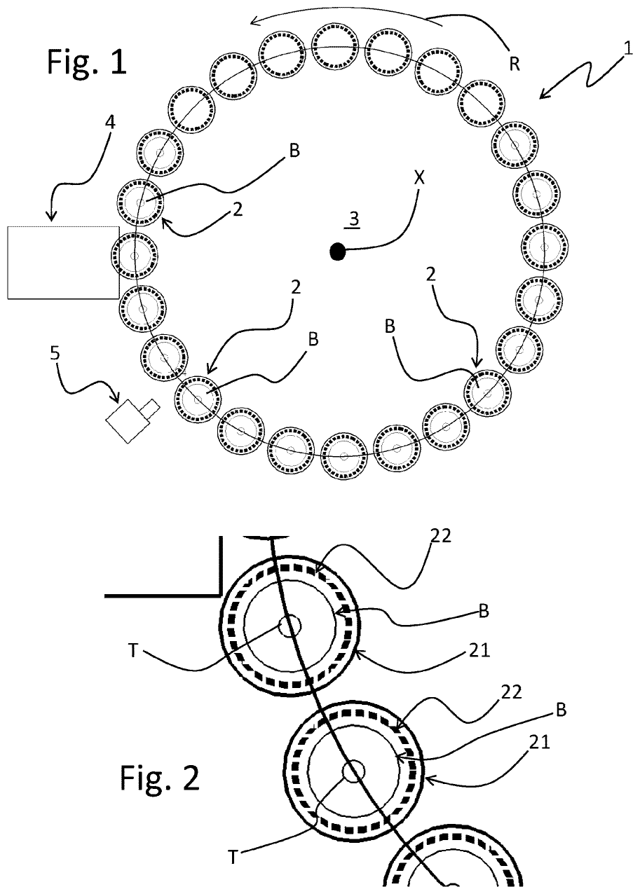

Each conveyor 3 is a carousel which is configured for rotating on itself to convey the units 2. The rotation axis X of the carousel 3 is indicated in FIG. 1. The rotation axis X is orthogonal to plane of FIG. 1.

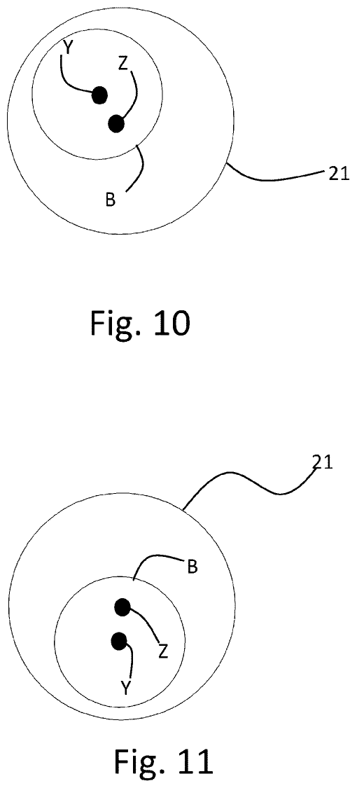

Each transporting unit 2 comprises a respective lower support 21 for supporting the bottom F of the container B. At least one lower support 21 is indicated in FIGS. 2, 5, 6, 7, 8, 9, 10 and 11. In FIGS. 10 and 11 the lower support 21 is shown from above. FIGS. from 5 to 9 lie on a plane which is orthogonal with respect to the plane of the other Figures.

Each lower support 21 is rotatable on itself while being conveyed, so that each container B is labelled while being transported and while rotating on itself. In FIG. 10 the lower support adopts a first angular position. In FIG. 11 the lower support 21 adopts a second angular position.

Each transporting unit 2 comprises a respective upper support 22. The upper support 22 is configured for holding the container B on the lower support 21 by acting on the top T of the container B. The upper support 22 is configured for pressurizing the inner volume V of the container. At least one upper support 22 is indicated in FIGS. 2, 5, 6, 7, 8, and 9.

The pressurization of the inner volume V is in particular needed in case the containers are labelled while not being already filled with the product, in an empty bottle labelling mode of the machine.

Each transporting unit 2 comprises a respective pressurization device 223. The pressurization device 223 is configured for pressurizing the inner volume V of the container B, by generating a fluid pressurization in the inner volume V of the container B.

Each transporting unit 2 comprises a holding head 221 for holding the top T of the container. The holding head 221 may be for example a gripping head or a plug.

Each transporting comprises a respective actuation device 222 for pressing the head 221 against the action of the pressurization, to hold the container B on the lower support 21. Therefore, the pressurization compensates the pressing action of the head 222, and viceversa.

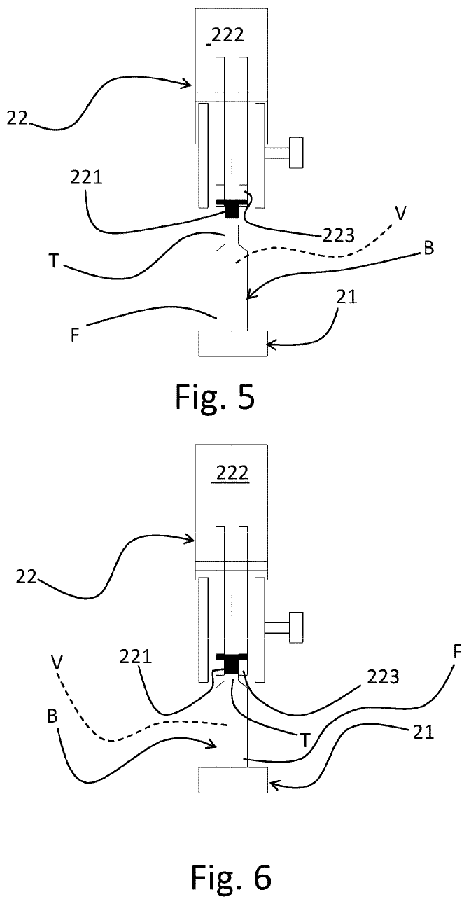

In FIG. 5 the transporting unit adopts a first configuration in which the container is still not pressurized and the holding head is still not holding the container. FIG. 6 shows a second configuration in which the container is kept by the holding head 221 on the lower support 21 and the inner volume V is pressurized. Each container is decorated in the situation of FIG. 6. In particular the pressurization is useful if the container is decorated while not being already filled with the product to be packaged.

The machine 1 comprises a monitoring unit 5. The monitoring unit 5 is configured for automatically and visually monitoring the deformation of the containers being conveyed to automatically detect, based on the monitored deformation, the operative condition of at least one of said devices and the level of defectiveness of the containers.

The monitoring unit 5 is radially offset with respect to the transporting units 2, relative to the rotation axis X of the carousel 3.

The monitoring unit 5 is positioned downstream of the module 4, according to the conveying direction R.

The monitoring unit 5 may comprise at least one visual sensor and a processing module for processing signal generated by the sensor.

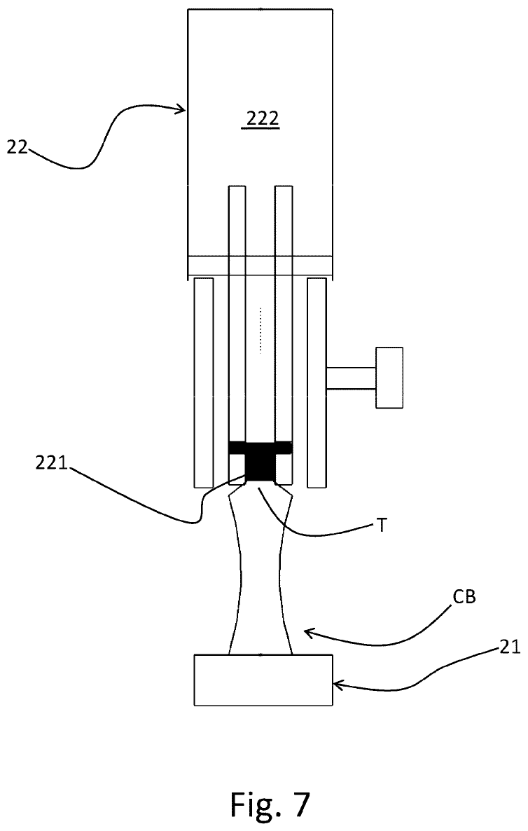

The monitoring unit 5 is configured for automatically detecting a problem of too low pressure in the pressurization devices or a too high defectiveness of the container if at least one container is collapsed on the support 21. A collapsed container is indicated with CB in FIG. 7. Said too high defectiveness may correspond to the container being perforated.

The monitoring unit 5 is configured for automatically discriminating between said problem and said too high defectiveness based on the number of collapsed containers. The monitoring unit 5 may be configured so that the problem is detected if the number of collapsed containers is above a preestablished threshold value. In this way, the process of monitoring is more useful and more reliable, in that the monitoring unit 5 is able to automatically distinguish between two different kinds of issues which otherwise could be confused.

The pressurization devices of the transporting units 2 share the same pressurization circuit. In this case, certain number of collapsed can indicate that there is a certain likelihood of an accrual problem in the pressurization circuit. Therefore, the monitoring unit 5 allows for improving the control or checking activity of an operator, regarding possible problems affecting the components of the transporting units or the containers B.

The monitoring unit 5 is configured for automatically detecting a problem of too high pressure in the pressurization devices if at least one container is too swollen. A too swollen container is indicated in FIG. 9 with SB.

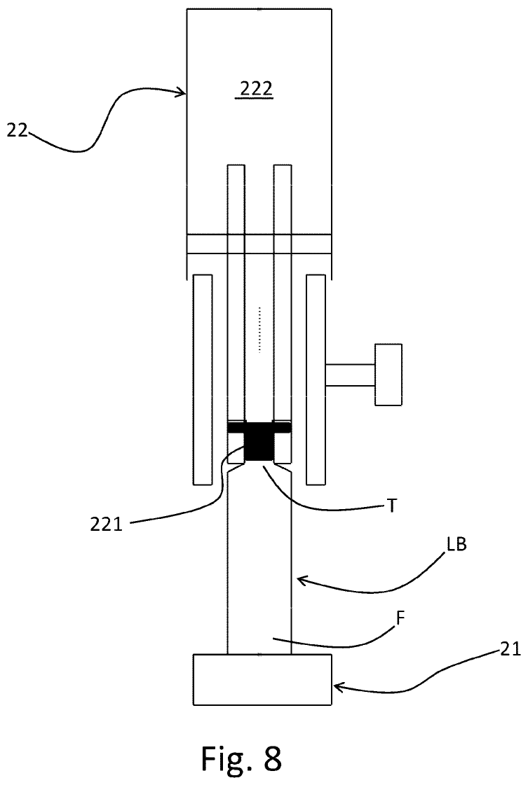

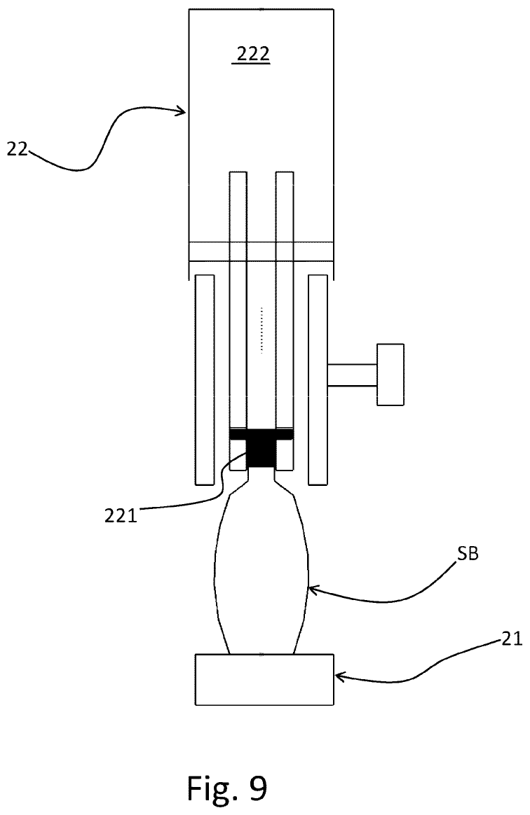

The monitoring unit 5 is configured for automatically detecting a problem in the actuation devices if at least one container B is too long from the bottom F to the top T. A too long container is indicated with LB in FIG. 8. A too high length of the container B is in fact probably due to the actuation device being not able to correctly contrasting the action of the pressurization device 223, which is working correctly. A too long container may be a container having a length which is bigger than a predetermined threshold length. The containers may be bottles. In this case, the bottom F is the base of the bottle and the top T is the neck of the bottle.

Each actuation device 222 comprises a respective fluid spring. The respective actuation devices 222 of the transporting units 2 share the same fluid circuit, which is preferably a pneumatic circuit.

Each actuation device can comprise a respective jack.

The monitoring unit 5 is configured for automatically informing a user selectively about the detected defectiveness and/or the detected problem. In this way the user can control the operative status of the machine 1 in a more reliable manner, to avoid or reduce the risk of a worsening of the components of the machine 1. To this end the machine 1 may comprise a user interface

The monitoring unit 5 comprises a camera or fotocamera 51. The monitoring unit 5 may comprise for example a smart camera.

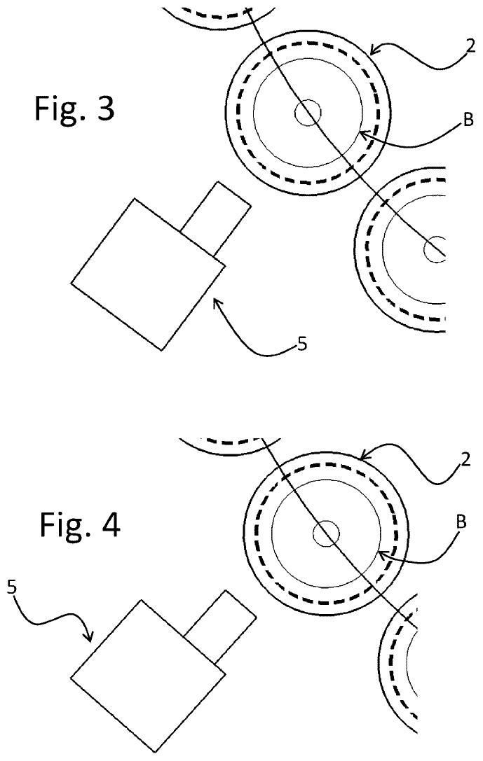

The monitoring unit 5 is configured for automatically acquiring at least two subsequent images of each container being conveyed, to automatically detect a possible decentralization of the container with respect to the support 21. The monitoring unit 5 is configured for moving to follow the conveying movement of the lower support 21 during acquisition. In FIG. 3 the monitoring unit 5 is obtaining a first image. In FIG. 4 the monitoring unit 5 is obtaining a second image of the same container. Thanks to the monitoring unit 5 being movable to follow the movement of the container B, it may be easier from a processing point of view to correlate the features of the images to the level of decentralization, notwithstanding the radial offset of the monitoring unit 5 with respect to the transporting units 2. By means of more than one image, it is possible to accurately detect a possible decentralization notwithstanding the radial offset of the monitoring unit 5 with respect to the transporting units 2. Alternatively the monitoring unit 5 can be fixed to remain in the same position during all the image acquisitions for the same container.

The monitoring unit 5 is configured preferably for automatically informing a user about the detected decentralization.

The machine 1 may be configured for automatically regulating an angular offset between the carousel 3 and an input starwheel, to reduce or correct the decentralization. The input starwheel is for inputting the containers to be decorated in the carousel 3.

Each lower support 21 comprises a respective circular plate. Each container presents a longitudinal axis Y extending from the bottom F to the top T. The decentralization corresponds to an offset between the axis Y of the container and the axis Z of the plate. In FIGS. 10 and 11 there is a an offset between the axis Y of the container B and the axis Z of the lower support 21. In FIGS. 10 and 11, the axes Y and Z are orthogonal to the plane of the Figures.

The monitoring unit 5 is configured for automatically and visually monitoring each lower support 21, to automatically detect a level of wear of each lower support 21. The monitoring unit 5 is configured for automatically informing a user about the detected wear. In particular, the monitoring of the wear of the lower supports 21 may occur in a set-up condition of the machine 1.

The monitoring unit 5 is configured for automatically and visually monitoring the conveyor 3, in a setup condition of the machine 1, to automatically detect a possible absence of at least one support 21. The monitoring unit 5 is configured for automatically informing a user about the detected absence.

The machine 1 may be for decorating containers. The labelling module may be a decorating module. The decorating module may alternatively be a printing module, which decorates the containers for example by means of a contactless process, like for example by means of laser. The printing module may also be a module which is configured for decorating the containers by inkjet.

It is therefore provided a decorating machine provided with a monitoring unit which is configured for monitoring in a very reliable manner the operative status of the transporting units of the machine.

1. A decorating machine for decorating containers comprising:
a plurality of transporting units for transporting respective containers;
a conveyor configured for conveying the units so that the containers are transported by means of the units being conveyed;
a decorating module positioned on the periphery of the conveyor, the machine being configured so that the transported containers are sequentially decorated while being transported;
wherein each transporting unit comprises:
a respective lower support for supporting the bottom of the container;
a respective upper support for holding the container on the lower support by acting on the top of the container, and for pressurizing the inner volume of the container, the upper support comprising:
a respective pressurization device for pressurizing the inner volume of the container, by generating a fluid pressurization in the inner volume of the container;
a respective holding head for holding the top of the container;
a respective actuation device for pressing the head against the action of the pressurization, to hold the container on the lower support; and
wherein the machine further comprises a monitoring unit which is configured for automatically and visually monitoring the deformation of the containers being conveyed to automatically detect, based on the monitored deformation, the operative condition of at least one of said devices and the level of defectiveness of the containers.

2. The machine according to claim 1, wherein the monitoring unit is configured to automatically detect a problem of too low pressure in a respective one of the pressurization devices or a too high defectiveness of the container if at least one container is collapsed on the support.

3. The machine according to claim 1, wherein the monitoring unit is configured to automatically discriminate between said problem of too low pressure and said too high defectiveness based on the number of collapsed containers, so that the problem is detected if the number of collapsed containers is above a preestablished threshold value.

4. The machine according to claim 3, wherein each of the respective pressurization devices of the transporting units share a same pressurization circuit.

5. The machine according to claim 1, wherein the monitoring unit is configured to automatically detect a problem of too high pressure in the pressurization devices if at least one container is too swollen.

6. The machine according to claim 1, wherein the monitoring unit is configured to automatically detect a problem in the actuation devices if at least one container is too long from the bottom to the top.

7. The machine according to claim 6, wherein each actuation device comprises a respective fluid spring and the actuation devices of the transporting units share a same fluid circuit.

8. The machine according to claim 1, wherein the monitoring unit is configured to automatically inform a user selectively about the detected defectiveness, a detected problem, or both.

9. The machine according to claim 1, wherein said monitoring unit comprises a camera or fotocamera.

10. The machine according to claim 1, wherein the monitoring unit is configured to automatically acquire at least two subsequent images of each container being conveyed, to automatically detect a decentralization of the container with respect to the lower support, the monitoring unit being configured to automatically inform a user about the detected decentralization and being configured to move during acquisition to follow a conveying movement of the lower support.

11. The machine according to claim 10, wherein each lower support comprises a respective plate having an axis (Z) and each container presents a longitudinal axis (Y) extending from the bottom to the top, said decentralization corresponding to an offset between the axis (Y) of the container and the axis (Z) of the plate.

12. The machine according to claim 1, wherein the monitoring unit is configured to automatically and visually monitor each lower support to automatically detect a level of wear of each of the lower supports, and the monitoring unit being configured to automatically inform a user about the detected wear.

13. The machine according to claim 12, wherein the monitoring unit is configured to automatically and visually monitor the conveyor in a setup configuration of the machine to automatically detect an absence of at least one support, and the monitoring unit being configured to automatically inform a user about the detected absence.

14. The machine according to claim 1, wherein the conveyor is a carousel configured to rotate on itself to convey the transporting units, wherein each lower support is rotatable on itself with respect to the carousel while being conveyed by the carousel, so that each container is decorated while being conveyed and while rotating on itself, and wherein the monitoring unit is radially offset with respect to the transporting units relative to a rotation axis (X) of the carousel.

15. A monitoring unit for a decorating machine according to claim 1.
